(19) United States
(12) Patent Application Publication
(10) Pub. No.: US 2025/0298814 A1
(43) Pub. Date: Sep. 25, 2025

(54) INDICATOR EVALUATION METHOD AND INDICATOR EVALUATION SYSTEM OF CLUSTER STABILITY

(71) Applicant: PROFET AI TECHNOLOGY CO., LTD., Taipei City (TW)

(72) Inventors: Chia-Hao CHEN, Taipei City (TW); Yu-Chi YANG, Taipei City (TW); Li-Ru HSU, Taipei City (TW)

(21) Appl. No.: 19/082,244

(22) Filed: Mar. 18, 2025

(30) Foreign Application Priority Data
Mar. 21, 2024 (TW) 113110627

(51) Int. Cl. G06F 16/28

(52) U.S. Cl. CPC G06F 16/285

(57) ABSTRACT

The present invention is an indicator evaluation method of a cluster stability, which is executed by an indicator evaluation system of a cluster stability. The indicator evaluation system includes a processing device. The processing device uniformly down-samples a raw data to be clustered to generate sub-data. The processing device calculates similarities of the sub-data according to a statistical test, and keeps the sub-data with the similarities greater than a similarity threshold as sub-data to be analyzed. The processing device clusters the sub-data to be analyzed to generate sub-data cluster results. The processing device organizes cluster label models of the sub-data cluster results, and generates organized sub-data cluster results according to organized cluster label models. The processing device further calculates a cluster stability indicator according to the organized sub-data cluster results. The present invention provides a reference indicator for evaluating stability of cluster results, and misleading results can be reduced.

### BACKGROUND OF THE INVENTION

### 1. Field of the Invention

The present invention relates to an indicator evaluation method and an indicator evaluation system, particularly to an indicator evaluation method and an indicator evaluation system of a cluster stability thereof.

### 2. Description of the Related Art

With regard to data analyses, a user usually desires to utilize a stability indicator to evaluate rationality of a cluster result according to each probability and each variability of various data.

For instance, referring to FIG. 8, a raw data 12 comprises a plurality of data points and the plurality of data points are randomly distributed. When the data points are clustered, the data points with similar feature are clustered as a same cluster label. Furthermore, cluster labels are set to all data points so that the data points are clustered as multiple groups. For instance, when the raw data 12 are clustered as three groups, the data points on the left half side are clustered as two groups with an upper part and a lower part, and the data points on the right half side are clustered as one group. Accordingly, the raw data 12 are clustered in the three groups.

However, whether the cluster results are good, bad, or rational depends on subjective perceptions of the user. Consequently, whether the cluster results are good, bad, or rational fails to be defined by the indicator. For instance, the cluster results in FIG. 8 and in FIG. 9 are clustered by two cluster algorithms. According to subjective perceptions of the user, the user usually thinks that the cluster result in FIG. 9 is better than the cluster result in FIG. 8. However, according to the current indicator values, such as the contour coefficients, the current indicator values are respectively evaluated as 0.50 and 0.26. Therefore, the indicator value of FIG. 8 is superior to the indicator value of FIG. 9. That is, the cluster results in FIG. 8 are better than the cluster results in FIG. 9.

As mentioned above, since the current indicator value fails to be applied to most conditions, the present invention provides a novel cluster stability evaluation method and a system thereof to mitigate the above problems.

### SUMMARY OF THE INVENTION

In view of the above problems, the present invention provides an indicator evaluation method of a cluster stability and an indicator evaluation system thereof. The method and the system generate a cluster stability indicator to the user for evaluating the stability and rationality of the cluster results.

The indicator evaluation method of the cluster stability comprises the following steps: uniformly down-sampling a raw data to be clustered to generate a plurality of groups of sub-data thereof; calculating a plurality of similarities of the raw data to be clustered with the plurality of groups of the sub-data according to at least one statistical test; keeping the plurality of groups of the sub-data with the plurality of similarities greater than a similarity threshold as a plurality of groups of the sub-data to be analyzed; clustering the plurality of groups of the sub-data to be analyzed according to a cluster algorithm to generate a plurality of the sub-data cluster results; organizing a plurality of cluster label models of the sub-data cluster results and generating a plurality of organized sub-data cluster results according to the organized cluster label models; and calculating a cluster stability indicator according to the organized sub-data cluster results.

The indicator evaluation system of the cluster stability comprises a processing device. The processing device uniformly down-samples a raw data to be clustered to generate a plurality of groups of the sub-data. The processing device calculates a plurality of similarities of the raw data to be clustered with the plurality of groups of the sub-data according to at least one statistical test. The processing device keeps the plurality of groups of the sub-data with the plurality of similarities greater than a similarity threshold as a plurality of groups of the sub-data to be analyzed and clusters the plurality of groups of the sub-data to be analyzed according to a cluster algorithm to generate a plurality of the sub-data cluster results. The processing device organizes a plurality of cluster label models of the sub-data cluster results, generates a plurality of organized sub-data cluster results according to the organized cluster label models, and calculates a cluster stability indicator according to the organized sub-data cluster results.

The indicator evaluation method of the cluster stability of the present invention provides a reference indicator. The reference indicator is the cluster stability indicator, utilized to evaluate the stability of the cluster results and to provide a determination according to the stability of the cluster results. When the cluster results are generated by distinct cluster coefficients, the cluster stability indicator provides a unity of a reference indicator to the user. The user utilizes the unity of the reference indicator to evaluate the stability of the cluster results. By this way, the user has more confidence to decide according to the cluster results. In addition, the cluster stability indicator is utilized to quantify an uncertainty. It is significantly critical for risk management, decision making, and stability of the system. The cluster stability indicator allows the user to more carefully utilize the cluster results and misleading results can be reduced.

### BRIEF DESCRIPTION OF THE DRAWINGS

FIG. 1 is one flowchart of the indicator evaluation method of the cluster stability in the present invention;

FIG. 2 is the schematic diagram for uniformly down-sampling a raw data to be clustered by the indicator evaluation method of the cluster stability;

FIG. 3A is one flowchart of the first embodiment for preprocessing the raw data of the indicator evaluation method of the cluster stability;

FIG. 3B is the flowchart of the second embodiment for preprocessing the raw data of the indicator evaluation method of the cluster stability;

FIG. 4 is another flowchart of the indicator evaluation method of the cluster stability in the present invention;

FIG. 5 is another flowchart of the indicator evaluation method of the cluster stability in the present invention;

FIG. 6 is the schematic diagram of the final cluster results of the indicator evaluation method of the cluster stability in the present invention;

FIG. 7 is the block schematic diagram of the indicator evaluation method of the cluster stability in the present invention;

FIG. 8 is the schematic diagram for clustering the raw data by one cluster algorithm; and

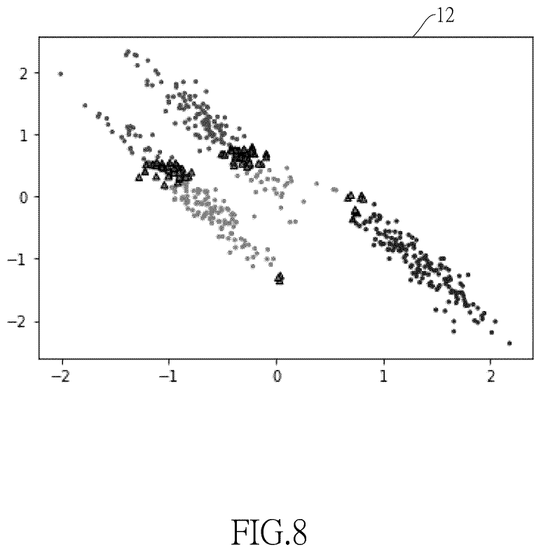

FIG. 9 is the schematic diagram for clustering the raw data by another cluster algorithm.

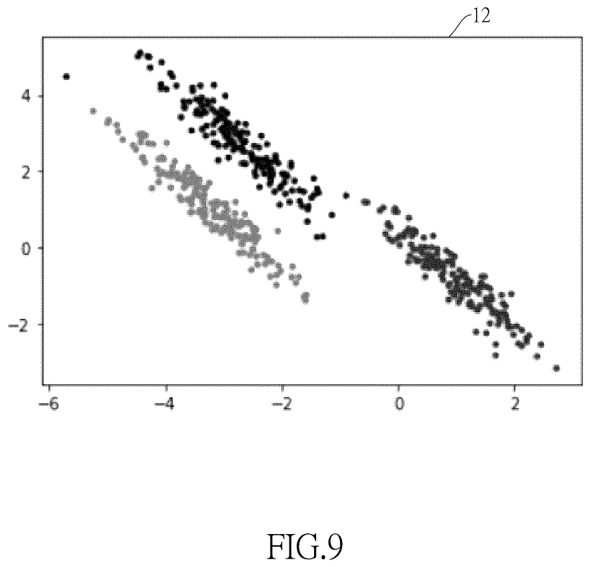

### DETAILED DESCRIPTION OF THE INVENTION

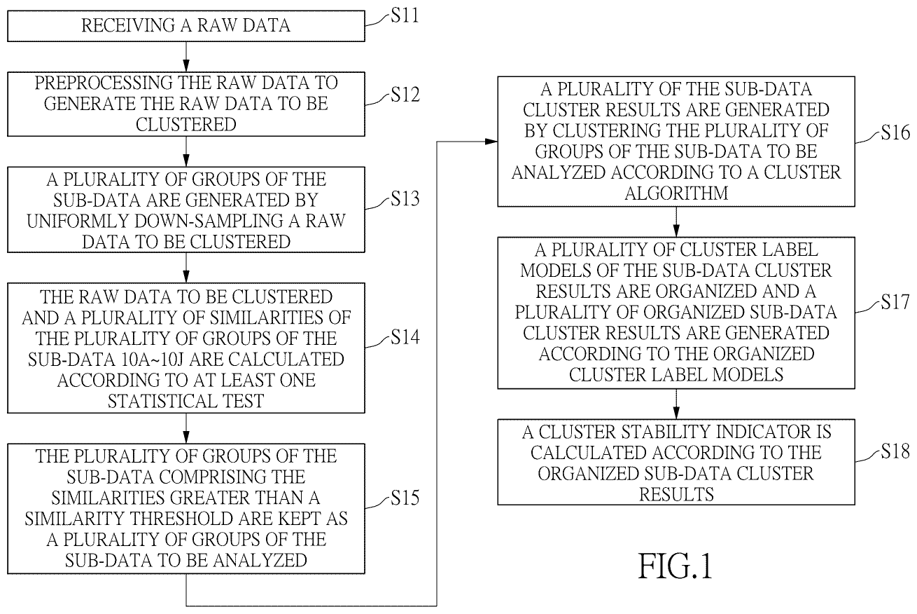

Referring to FIG. 1, the present invention provides an indicator evaluation method of the cluster stability, comprising the following steps.

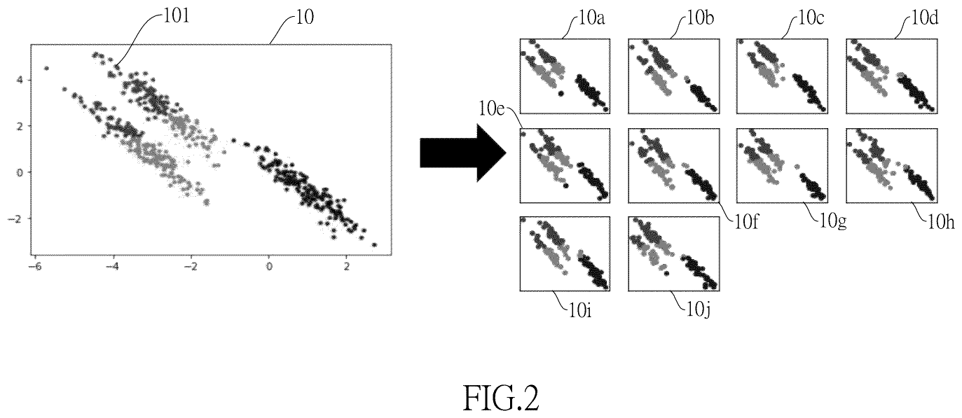

In step S13, a plurality of groups of the sub-data are generated by uniformly down-sampling a raw data to be clustered. As shown in FIG. 2, the raw data to be clustered 10 comprises a plurality of data points 101 and the plurality of groups of the sub-data 10a˜10j are generated by uniformly down-sampling. For instance, the plurality of data points 101 are kept at equal intervals by uniformly down-sampling the plurality of groups of the sub-data 10a˜10j. The plurality of groups of the sub-data 10a˜10j are generated by uniformly down-sampling at distinct intervals. Consequently, the sampling point of each group of the sub-data 10a˜10j is not fully the same. Moreover, the sampling point of each group of the sub-data 10a˜10j is not the same with the data points 101 of the raw data to be clustered 10. Hence, the raw data to be clustered 10 and the plurality of groups of the sub-data 10a˜10j are various.

In step S14, the raw data to be clustered 10 and a plurality of similarities of the plurality of groups of the sub-data 10a˜10j are calculated according to at least one statistical test. In an embodiment of the present invention, the statistical test comprises at least one comprehensive evaluation but not limited to Chi-Squared Test, T Student's t-test, or F-test.

In step S15, the plurality of groups of the sub-data comprising the similarities greater than a similarity threshold are kept as a plurality of groups of the sub-data to be analyzed. For instance, when the similarities greater than 80% of the similarity threshold, it represents that the retained data point 101 of the plurality of groups of the sub-data to be analyzed and the data point 101 of the raw data to be clustered 10 have more than 80% similarity.

In step S16, a plurality of the sub-data cluster results are generated by clustering the plurality of groups of the sub-data to be analyzed according to a cluster algorithm. In an embodiment of the present invention, the cluster algorithm comprises a k-means clustering algorithm. For instance, when the cluster algorithm is utilized, a parameter of the algorithm needs to be set. For example, when the k-means algorithm is utilized, the parameter of the cluster amount needs to be set. When the cluster amount n_cluster=3, the data point 101 is clustered as three groups by the k-means algorithm. As shown in FIG. 2, a plurality of data points 101 of the raw data to be clustered 10 are clustered as three groups by the k-means algorithm; wherein the three groups are represented by different colors. Similarly, the sub-data 10a˜10j are clustered as three groups by the k-means algorithm and represented by different colors.

In step S17, a plurality of cluster label models of the sub-data cluster results are organized and a plurality of organized sub-data cluster results are generated according to the organized cluster label models.

In step S18, a cluster stability indicator is calculated according to the organized sub-data cluster results.

The indicator evaluation method of the cluster stability of the present invention provides a reference indicator. The reference indicator is the cluster stability indicator, utilizing to evaluate the stability of the cluster results and to provide a determination according to the stability of the cluster results. When the cluster results are generated by distinct cluster coefficients, the cluster stability indicator provides a unity of a reference indicator to the user. The user utilizes the unity of the reference indicator to evaluate the stability of the cluster results. By this way, the user has more confidence to decide according to the cluster results. In addition, the cluster stability indicator is utilized to quantify an uncertainty. It is significantly critical for risk management, decision making, and stability of the system. The cluster stability indicator allows the user to more carefully utilize the cluster results and misleading results can be reduced. For instance, the lower the cluster stability indicator is, the higher the uncertainty of the cluster results is. In contrast, the higher the cluster stability indicator is, the lower the uncertainty of the cluster results is.

Furthermore, before step S13, the method further comprises the following steps:
Step S11, receiving a raw data; and
Step S12, preprocessing the raw data to generate the raw data to be clustered 10.

When the raw data is received, the raw data is preprocessed and arranged to be uniform. By this way, the uniformed raw data is easily processed in subsequent steps. Therefore, the performance and the accuracy of the method can be improved.

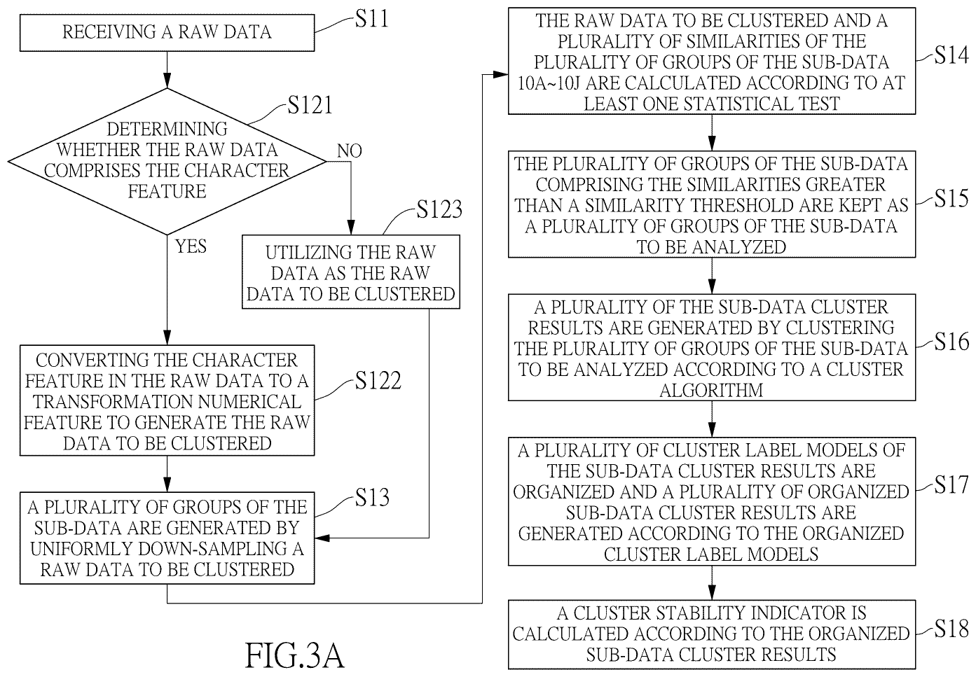

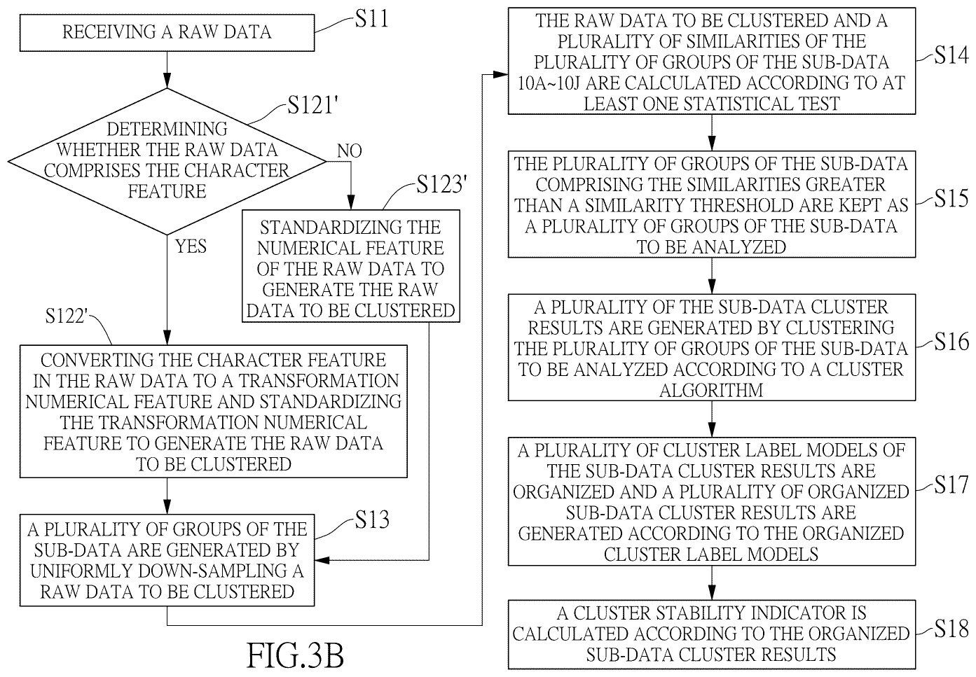

Referring to FIG. 3A, in the first embodiment of preprocessing the raw data, the raw data at least comprises one numerical feature or one character feature. In detail, step S12 comprises the following sub-steps:
Step S121, determining whether the raw data comprises the character feature;
Step S122, when the raw data comprises the character feature, converting the character feature in the raw data to a transformation numerical feature to generate the raw data to be clustered 10; and

Step S123, when the raw data excludes the character feature, utilizing the raw data as the raw data to be clustered 10.

Since the cluster algorithm needs to receive a value, the character feature is converted when the raw data comprises the character feature. For instance, the character feature is converted by a one hot encoder. The converting method is not limited to the one hot encoder but any method by which the character feature is able to be converted to the transformation numerical feature to generate the raw data to be clustered 10 is included in the embodiment of the present invention, such as Ordinal Encoder, Binary Encoder, and so on.

Moreover, referring to FIG. 3B, in the second embodiment of preprocessing the raw data, the raw data at least comprises one numerical feature or one character feature. In detail, step S12 comprises the following sub-steps:
Step S121′, determining whether the raw data comprises the character feature;
Step S122′, when the raw data comprises the character feature, converting the character feature in the raw data to a transformation numerical feature.

Furthermore, the transformation numerical feature is standardized to generate the raw data to be clustered 10. In an embodiment of the present invention, the character feature is converted to the transformation numerical feature by the one hot encoder. The transformation numerical feature and the numerical feature are standardized by a min max standard scale algorithm; and
Step S123′, when the raw data excludes the character feature, standardizing the numerical feature of the raw data to generate the raw data to be clustered 10.

According to the cluster method of Euclidean distance, when the scale of the values is significantly various, the feature with huge scale dominates the cluster results. Hence, the method of the present invention utilizes the min max standard scale algorithm to standardize the numerical feature so that the numerical feature is converted to the same scale range. The method for standardizing the numerical feature is not limited to the min max standard scale algorithm but any preprocess by which the numerical feature is able to be standardized is included in the embodiment of the present invention, such as Standard Transformation, Box-Cox Transformation, and so on.

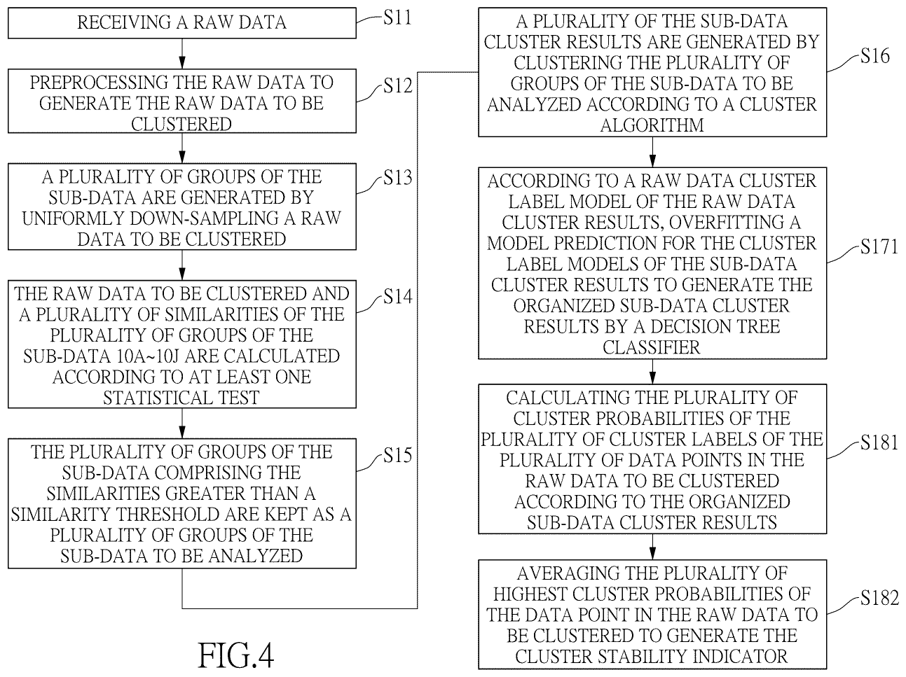

In detail, referring to FIG. 4, step S17 comprises the following sub-step:

Step S171, according to a raw data cluster label model of the raw data cluster results, overfitting a model prediction for the cluster label models of the sub-data cluster results to generate the organized sub-data cluster results by a decision tree classifier.

The decision tree fails to completely control a growing and a pruning so that the decision tree is able to perfectly compare an input (X) and an output (Y).

When the sub-data cluster results are clustered, the corresponding cluster amount is generated. For instance, when the plurality of groups of the sub-data to be analyzed is clustered as three groups, but three groups of the sub-data to be analyzed uncertainly have the same cluster label models. For example, the cluster label model of the first group of the sub-data to be analyzed may comprise ABC of the name and the sequence, but the cluster label model of the first group of the sub-data to be analyzed may comprise CBA of the name and the sequence. That is, when the sub-data cluster results are clustered by different cluster label models, incorrect sub-data cluster results are generated. However, whatever the cluster label models are used, the plurality of groups of the sub-data to be analyzed per se fail to be varied. Hence, the method of the present invention organizes the cluster label models of the sub-data cluster results to unify the cluster label models of the sub-data cluster results. Accordingly, the incorrect sub-data cluster results caused by utilizing different cluster label models to cluster the sub-data cluster results can be avoided. In other words, after the cluster label models of the sub-data cluster results are unified, the plurality of groups of the sub-data to be analyzed are clustered as the same name and the sequence.

For instance, there are 10 sets for keeping the plurality of groups of the sub-data to be analyzed, as shown in Table 1.

TABLE 1

| | data points | | | | | | | | | |
|---|---|---|---|---|---|---|---|---|---|---|
| raw data to | \textcircled{1} | \textcircled{2} | \textcircled{3} | \textcircled{4} | \textcircled{5} | \textcircled{6} | \textcircled{7} | \textcircled{8} | \textcircled{9} | \textcircled{10} |
| be | | | | | | | | | | |
| clustered | | | | | | | | | | |
| sub-data 1 | | \textcircled{2} | \textcircled{3} | \textcircled{4} | \textcircled{5} | \textcircled{6} | \textcircled{7} | \textcircled{8} | \textcircled{9} | \textcircled{10} |
| sub-data 2 | \textcircled{1} | | \textcircled{3} | \textcircled{4} | \textcircled{5} | \textcircled{6} | \textcircled{7} | \textcircled{8} | \textcircled{9} | \textcircled{10} |
| sub-data 3 | \textcircled{1} | \textcircled{2} | | \textcircled{4} | \textcircled{5} | \textcircled{6} | \textcircled{7} | \textcircled{8} | \textcircled{9} | \textcircled{10} |
| sub-data 4 | \textcircled{1} | \textcircled{2} | \textcircled{3} | | \textcircled{5} | \textcircled{6} | \textcircled{7} | \textcircled{8} | \textcircled{9} | \textcircled{10} |
| sub-data 5 | \textcircled{1} | \textcircled{2} | \textcircled{3} | \textcircled{4} | | \textcircled{6} | \textcircled{7} | \textcircled{8} | \textcircled{9} | \textcircled{10} |
| sub-data 6 | \textcircled{1} | \textcircled{2} | \textcircled{3} | \textcircled{4} | \textcircled{5} | | \textcircled{7} | \textcircled{8} | \textcircled{9} | \textcircled{10} |
| sub-data 7 | \textcircled{1} | \textcircled{2} | \textcircled{3} | \textcircled{4} | \textcircled{5} | \textcircled{6} | | \textcircled{8} | \textcircled{9} | \textcircled{10} |
| sub-data 8 | \textcircled{1} | \textcircled{2} | \textcircled{3} | \textcircled{4} | \textcircled{5} | \textcircled{6} | \textcircled{7} | | \textcircled{9} | \textcircled{10} |
| sub-data 9 | \textcircled{1} | \textcircled{2} | \textcircled{3} | \textcircled{4} | \textcircled{5} | \textcircled{6} | \textcircled{7} | \textcircled{8} | | \textcircled{10} |
| sub-data 10 | | \textcircled{1} | \textcircled{2} | \textcircled{3} | \textcircled{4} | \textcircled{5} | \textcircled{6} | \textcircled{7} | \textcircled{8} | \textcircled{9} |

As shown in Table 1, the raw data to be clustered 10 has the data points □\textcircled{1}˜\textcircled{10}, the sub-data 1 has the data points \textcircled{2}˜\textcircled{10}, the sub-data 2 has the data points \textcircled{1}, \textcircled{3}˜\textcircled{10}, the sub-data 3 has the data points \textcircled{1}˜\textcircled{2}, \textcircled{4}˜\textcircled{10}, the sub-data 4 has the data points \textcircled{1}˜\textcircled{3}, \textcircled{5}˜\textcircled{10}, the sub-data 5 has the data points \textcircled{1}˜\textcircled{4}, \textcircled{6}˜\textcircled{10}, the sub-data 6 has the data points \textcircled{1}˜\textcircled{5}, \textcircled{7}˜\textcircled{10}, the sub-data 7 has the data points \textcircled{1}˜\textcircled{6}, \textcircled{8}˜\textcircled{10}, the sub-data 8 has the data points \textcircled{1}˜\textcircled{7}, \textcircled{9}˜\textcircled{10}, the sub-data 9 has the data points \textcircled{1}˜\textcircled{8}, \textcircled{10}, and the sub-data 10 has the data points \textcircled{1}˜\textcircled{9}; wherein the data points of the sub-data 1˜10 as the plurality of groups of the sub-data to be analyzed are more than 80% the same as the data point 101 of the raw data to be clustered 10.

For instance, the plurality of the cluster label models of the sub-data cluster results are organized by the following steps, but not limited thereto. In step \textcircled{1}, the cluster label model 1 of the raw data to be clustered 10 is built as M1. In step \textcircled{2}, the cluster label model 11 of the sub-data 1 is built as M11. In step \textcircled{3}, the cluster label model 1 (M1) is utilized to predict the sub-data 1 to generate the cluster results 1_1. The cluster results 1_1 are as shown in Table 2.

TABLE 2

| sub-data 1 | \textcircled{2} | \textcircled{3} | \textcircled{4} | \textcircled{5} | \textcircled{6} | \textcircled{7} | \textcircled{8} | \textcircled{9} | \textcircled{10} |
|---|---|---|---|---|---|---|---|---|---|
| cluster label | C | C | B | B | A | A | A | A | A |

In step \textcircled{4}, the cluster label model 11 (M11) is utilized to predict the sub-data 1 again to generate cluster results 11_1. The cluster results 11_1 are as shown in Table 3.

TABLE 3

| sub-data 1 | \textcircled{2} | \textcircled{3} | \textcircled{4} | \textcircled{5} | \textcircled{6} | \textcircled{7} | \textcircled{8} | \textcircled{9} | \textcircled{10} |
|---|---|---|---|---|---|---|---|---|---|
| cluster label | A | A | B | B | C | C | C | C | C |

In step \textcircled{5}, the cluster results 1_1 are used as the training data X (input) of the decision tree and the cluster results 11_1 are used as the training data Y (output) of the decision tree for training the decision tree 1. In step \textcircled{6}, the cluster label model 1 (M1) is utilized to predict the raw data to be clustered 10 to generate the cluster results 1_11. The cluster results 1_11 are as shown in Table 4 .

TABLE 4

| raw data to | | | | | | | | | | |
|---|---|---|---|---|---|---|---|---|---|---|
| be clustered | \textcircled{1} | \textcircled{2} | \textcircled{3} | \textcircled{4} | \textcircled{5} | \textcircled{6} | \textcircled{7} | \textcircled{8} | \textcircled{9} | \textcircled{10} |
| cluster label | C | C | C | B | B | A | A | A | A | A |

In step 7, the trained decision tree 1 is utilized to predict the cluster results 1_11 and to convert the cluster results 1_11 to generate the cluster results cluster results 1_11_C. The cluster results 1_11_C are as shown in Table 5.

TABLE 5

| raw data to | | | | | | | | | | |
|---|---|---|---|---|---|---|---|---|---|---|
| be clustered | \textcircled{1} | \textcircled{2} | \textcircled{3} | \textcircled{4} | \textcircled{5} | \textcircled{6} | \textcircled{7} | \textcircled{8} | \textcircled{9} | \textcircled{10} |
| cluster label | A | A | A | B | B | C | C | C | C | C |

After that, step \textcircled{2}˜step \textcircled{7} are repeated to respectively generate the cluster results 2˜10_11_C. The cluster results 2˜10_11_C are as shown in Table 6 to Table 14.

TABLE 6
(cluster results 2_11_C)

| raw data to | | | | | | | | | | |
|---|---|---|---|---|---|---|---|---|---|---|
| be clustered | \textcircled{1} | \textcircled{2} | \textcircled{3} | \textcircled{4} | \textcircled{5} | \textcircled{6} | \textcircled{7} | \textcircled{8} | \textcircled{9} | \textcircled{10} |
| cluster label | A | A | B | B | B | C | C | C | C | C |

TABLE 7
(cluster results 3_11_C)

| raw data to | | | | | | | | | | |
|---|---|---|---|---|---|---|---|---|---|---|
| be clustered | \textcircled{1} | \textcircled{2} | \textcircled{3} | \textcircled{4} | \textcircled{5} | \textcircled{6} | \textcircled{7} | \textcircled{8} | \textcircled{9} | \textcircled{10} |
| cluster label | A | A | B | B | B | B | C | C | C | C |

TABLE 8
(cluster results 4_11_C)

| raw data to | | | | | | | | | | |
|---|---|---|---|---|---|---|---|---|---|---|
| be clustered | \textcircled{1} | \textcircled{2} | \textcircled{3} | \textcircled{4} | \textcircled{5} | \textcircled{6} | \textcircled{7} | \textcircled{8} | \textcircled{9} | \textcircled{10} |
| cluster label | A | A | A | A | B | C | C | C | C | C |

TABLE 9
(cluster results 5_11_C)

| raw data to | | | | | | | | | | |
|---|---|---|---|---|---|---|---|---|---|---|
| be clustered | \textcircled{1} | \textcircled{2} | \textcircled{3} | \textcircled{4} | \textcircled{5} | \textcircled{6} | \textcircled{7} | \textcircled{8} | \textcircled{9} | \textcircled{10} |
| cluster label | A | B | B | B | B | C | C | C | C | C |

TABLE 10
(cluster results 6_11_C)

| raw data to | | | | | | | | | | |
|---|---|---|---|---|---|---|---|---|---|---|
| be clustered | \textcircled{1} | \textcircled{2} | \textcircled{3} | \textcircled{4} | \textcircled{5} | \textcircled{6} | \textcircled{7} | \textcircled{8} | \textcircled{9} | \textcircled{10} |
| cluster label | B | B | B | B | B | C | C | C | C | C |

TABLE 11
(cluster results 7_11_C)

| raw data to | | | | | | | | | | |
|---|---|---|---|---|---|---|---|---|---|---|
| be clustered | \textcircled{1} | \textcircled{2} | \textcircled{3} | \textcircled{4} | \textcircled{5} | \textcircled{6} | \textcircled{7} | \textcircled{8} | \textcircled{9} | \textcircled{10} |
| cluster label | A | A | A | B | B | B | B | C | C | C |

TABLE 12
(cluster results 8_11_C)

| raw data to | | | | | | | | | | |
|---|---|---|---|---|---|---|---|---|---|---|
| be clustered | \textcircled{1} | \textcircled{2} | \textcircled{3} | \textcircled{4} | \textcircled{5} | \textcircled{6} | \textcircled{7} | \textcircled{8} | \textcircled{9} | \textcircled{10} |
| cluster label | A | A | A | B | B | B | B | B | C | C |

TABLE 13
(cluster results 9 11 C)

| raw data to | | | | | | | | | | |
|---|---|---|---|---|---|---|---|---|---|---|
| be clustered | \textcircled{1} | \textcircled{2} | \textcircled{3} | \textcircled{4} | \textcircled{5} | \textcircled{6} | \textcircled{7} | \textcircled{8} | \textcircled{9} | \textcircled{10} |
| cluster label | A | A | A | A | A | C | C | C | C | C |

TABLE 14
(cluster results 10_11_C)

| raw data to | | | | | | | | | | |
|---|---|---|---|---|---|---|---|---|---|---|
| be clustered | \textcircled{1} | \textcircled{2} | \textcircled{3} | \textcircled{4} | \textcircled{5} | \textcircled{6} | \textcircled{7} | \textcircled{8} | \textcircled{9} | \textcircled{10} |
| cluster label | A | A | A | C | C | C | C | C | C | C |

In addition, step S18 further comprises the following sub-steps:
Step S181, calculating the plurality of cluster probabilities of the plurality of cluster labels of the plurality of data points 101 in the raw data to be clustered 10 according to the organized sub-data cluster results; and
Step S182, averaging the plurality of highest cluster probabilities of the data point 101 in the raw data to be clustered 10 to generate the cluster stability indicator.

For instance, when the aforementioned cluster results 1˜10_11_C are obtained, the cluster probabilities of each cluster label of the data points 101 in the raw data to be clustered 10 are calculated according to the cluster labels of the cluster results of the organized sub-data. For instance, taking the data point \textcircled{1} as an example, in the cluster results 1˜10_11_C, nine cluster labels in the cluster results are A, one cluster label in the cluster results is B, and no cluster label in the cluster results is C. Hence, the cluster probability of the cluster label of the data point \textcircled{1} calculated as A is (9/10)%=90%, the cluster probability of the cluster label of the data point \textcircled{1} calculated as B is (1/10)%=10%, and the cluster probability of the cluster label of the data point \textcircled{1} calculated as C is (0/10)%=0%. Similarly, the cluster probabilities of the cluster label of the data points \textcircled{2}˜\textcircled{10} can be calculated as A to C, as shown in Table 15.

| raw data to | | | | | | | | | | |
|---|---|---|---|---|---|---|---|---|---|---|
| be clustered | \textcircled{1} | \textcircled{2} | \textcircled{3} | \textcircled{4} | \textcircled{5} | \textcircled{6} | \textcircled{7} | \textcircled{8} | \textcircled{9} | \textcircled{10} |
| cluster label | 90% | 80% | 60% | 20% | 10% | 0% | 0% | 0% | 0% | 0% |
| A cluster | | | | | | | | | | |
| probability | | | | | | | | | | |
| cluster label | 10% | 20% | 40% | 70% | 80% | 30% | 20% | 10% | 0% | 0% |
| B cluster | | | | | | | | | | |
| probability | | | | | | | | | | |
| cluster label | 0% | 0% | 0% | 10% | 10% | 70% | 80% | 90% | 100% | 100% |
| C cluster | | | | | | | | | | |
| probability | | | | | | | | | | |

Then, the cluster stability indicator is calculated according to the following formula.

$$\frac{1}{M} {\sum }_{i = 1}^{M} max ( p r o b {a}_{i} )$$

Wherein M is the amount of the data point 101 in the raw data to be clustered 10. Taking the above embodiment for elaboration, M is 10, max(probaᵢ) is the highest cluster probability of each data point \textcircled{1}˜\textcircled{10}, and a₁˜a₁₀ are 90%, 80%, 60%, 70%, 80%, 70%, 80%, 90%, 100%, 100%, respectively. Consequently, the cluster stability indicator can be calculated according to the formula below.

$$\frac{1}{10} {\sum }_{i = 1}^{10} max ( p r o b {a}_{i} ) = \frac{\begin{matrix}90 \% + 80 \% + 60 \% + 70 \% + 80 \% + \\ 70 \% + 80 \% + 90 \% + 100 \% + 100 \%\end{matrix}}{10} = 82 \% = 0.82$$

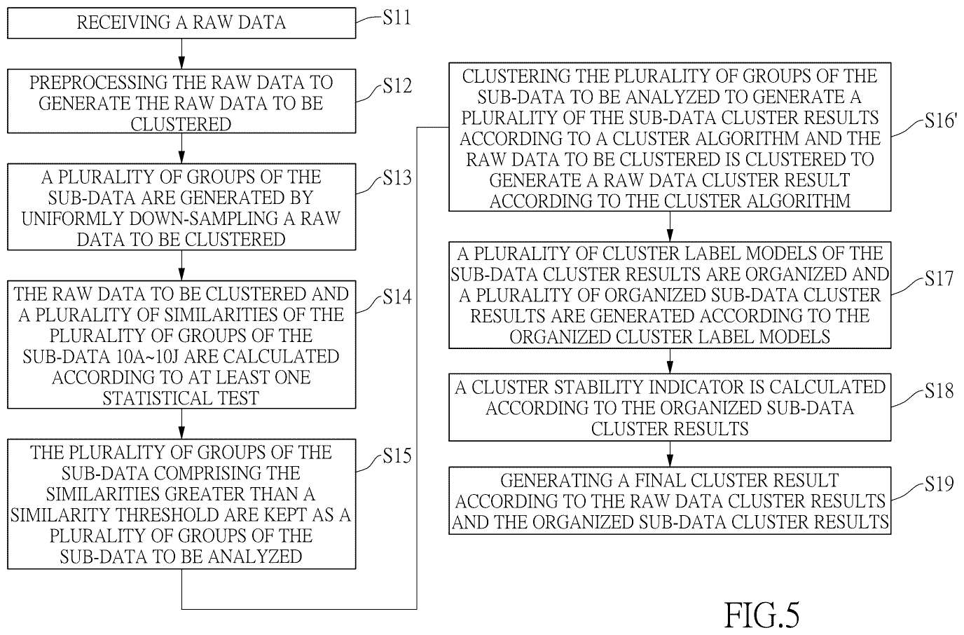

Referring to FIG. 5, in an embodiment of the present invention, step S16′ further comprises the following sub-step:
Step S16′, clustering the plurality of groups of the sub-data to be analyzed to generate a plurality of the sub-data cluster results according to a cluster algorithm, and clustering the raw data to be clustered 10 to generate a raw data cluster result according to the cluster algorithm.

The indicator evaluation method of the cluster stability further comprises the following step:
Step S19, generating a final cluster result according to the raw data cluster results and the organized sub-data cluster results. In an embodiment of the present invention, the final cluster result corresponds to the cluster stability indicator.

For instance, in the cluster probability of the final cluster result, the highest probability of the data points \textcircled{1}˜\textcircled{10} clustered as A˜C of the cluster label is utilized as the cluster label of the data points \textcircled{1}˜\textcircled{10}. For instance, the cluster probability of the cluster label of the data point \textcircled{1} clustered as A is 90%. The cluster probability of the cluster label of the data point \textcircled{1} clustered as B is 10%. The cluster probability of the cluster label of the data point \textcircled{1} clustered as C is 0%. Therefore, the cluster label of the data point \textcircled{1} is defined as A. Similarly, the cluster label of the data points \textcircled{2}˜\textcircled{10} can be confirmed in sequence and the final cluster result is generated as shown in Table 16 below.

TABLE 16
(final cluster results)

| raw data to | | | | | | | | | | |
|---|---|---|---|---|---|---|---|---|---|---|
| be clustered | \textcircled{1} | \textcircled{2} | \textcircled{3} | \textcircled{4} | \textcircled{5} | \textcircled{6} | \textcircled{7} | \textcircled{8} | \textcircled{9} | \textcircled{10} |
| cluster label | A | A | A | B | B | C | C | C | C | C |

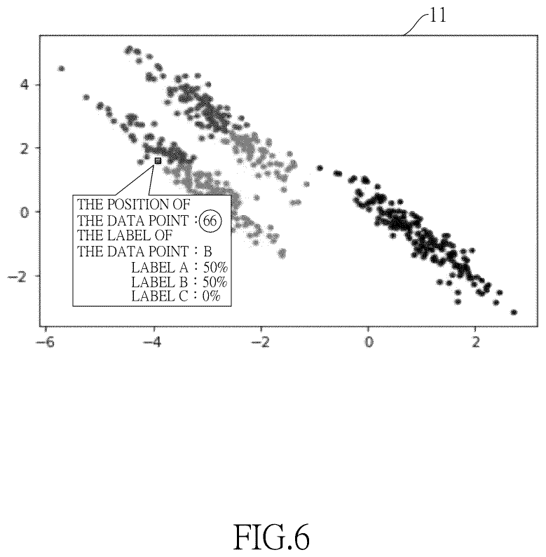

Furthermore, if the cluster probability of one of the data points is that there are two or more of the same, the cluster probability is defined according to the cluster label of the raw data cluster results. For instance, as shown in FIG. 6, if the probability of the data point \textcircled{66} defined as label A is 50%, the probability of the data point \textcircled{66} defined as label B is 50%, and the probability of the data point \textcircled{66} defined as label C is 0%, the probability of the data point \textcircled{66} fails to be confirmed according to the highest probability. In the meanwhile, the cluster label of the raw data cluster results is the reference. For instance, the cluster label of the data point \textcircled{66} in the raw data cluster results is B, and the cluster label of the data point \textcircled{66} in the final cluster result 11 is defined as B.

In an embodiment of the present invention, the higher the cluster stability indicator is, the higher the stability of the final cluster result is.

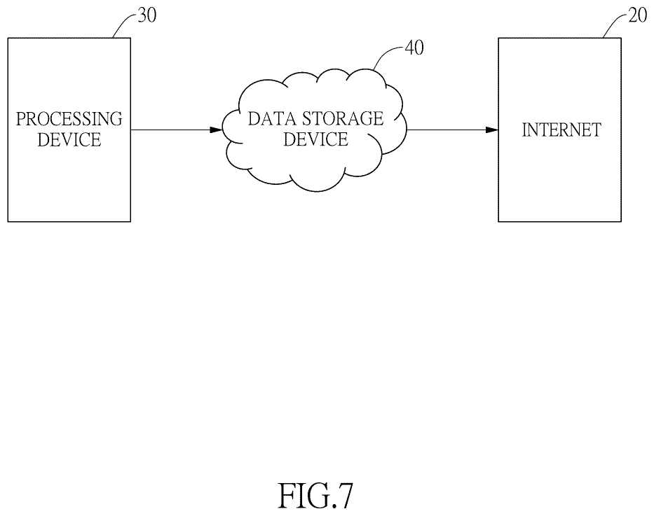

Referring to FIG. 7, the present invention further provides an indicator evaluation system of the cluster stability for performing the indicator evaluation method of the cluster stability. The indicator evaluation system of the cluster stability comprises a processing device 20. The processing device 20 uniformly down-samples a raw data to be clustered to generate a plurality of groups of the sub-data. The processing device 20 calculates a plurality of similarities of the raw data to be clustered with the plurality of groups of the sub-data according to at least one statistical test. The processing device 20 keeps the plurality of groups of the sub-data with the plurality of similarities greater than a similarity threshold as a plurality of groups of the sub-data to be analyzed and clusters the plurality of groups of the sub-data to be analyzed according to a cluster algorithm to generate a plurality of the sub-data cluster results. The processing device 20 organizes a plurality of cluster label models of the sub-data cluster results. The processing device 20 generates a plurality of organized sub-data cluster results according to the organized cluster label models. The processing device 20 calculates a cluster stability indicator according to the organized sub-data cluster results.

In detail, the indicator evaluation system of the cluster stability further comprises a data storage device 30. The data storage device 30 stores a raw data. The processing device 20 is communicatively connected to the data storage device 30 to access the raw data and preprocesses the raw data to generate the raw data to be clustered. In an embodiment of the present invention, the processing device 20 is communicatively connected to the data storage device 30 via Internet 40.

In an embodiment, the statistical test comprises at least one comprehensive evaluation but not limited to Chi-Squared Test, T Student's t-test, or F-test. The cluster algorithm comprises a k-means algorithm (k-means clustering).

In the first embodiment for preprocessing the raw data, the raw data comprises at least a numerical feature or a character feature. The processing device 20 determines whether the raw data comprises the character feature when the processing device preprocesses the raw data. When the raw data comprises the character feature, the processing device 20 converts the character feature in the raw data as a transformation numerical feature to generate the raw data to be clustered. When the raw data excludes the character feature, the processing device 20 utilizes the raw data as the raw data to be clustered.

In the second embodiment for preprocessing the raw data, the raw data comprises at least a numerical feature or a character feature. When the processing device 20 preprocesses the raw data, the processing device 20 determines whether the raw data comprises the character feature. When the raw data comprises the character feature, the processing device 20 converts the character feature in the raw data as a transformation numerical feature and standardizes the transformation numerical feature to generate the raw data to be clustered. When the raw data excludes the character feature, the processing device 20 standardizes the numerical feature of the raw data to generate the raw data to be clustered.

In an embodiment, the processing device 20 utilizes a One Hot Encoder to convert the character feature to the transformation numerical feature. The processing device 20 standardizes the transformation numerical feature and the numerical feature by Min Max Standard Scale algorithm.

When the processing device 20 organizes the cluster label models of the sub-data cluster results and generates the organized sub-data cluster results according to the organized cluster label models, the processing device 20 utilizes a decision tree classifier to overfit a model prediction for the cluster label models of the sub-data cluster results according to a raw data cluster label model of the raw data cluster results to generate the organized sub-data cluster results.

When the processing device 20 calculates the cluster stability indicator according to the organized sub-data cluster results, the processing device 20 calculates a plurality of cluster probabilities of a plurality of cluster labels of a plurality of data points in the raw data to be clustered according to the organized sub-data cluster results. The processing device 20 further averages the plurality of highest cluster probabilities of the plurality of data points in the raw data to be clustered to generate the cluster stability indicator.

When the processing device 20 clusters the plurality of groups of the sub-data to be analyzed according to the cluster algorithm to generate a plurality of the sub-data cluster results, the processing device 20 clusters the raw data to be clustered to generate a raw data cluster result according to the cluster algorithm. The processing device 20 generates a final cluster result according to the raw data cluster results and the organized sub-data cluster results. The final cluster result corresponds to the cluster stability indicator.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An indicator evaluation method of a cluster stability, comprising the following steps:
uniformly down-sampling a raw data to be clustered to generate a plurality of groups of sub-data thereof;
calculating a plurality of similarities of the raw data to be clustered with the plurality of groups of sub-data according to at least one statistical test;
keeping the plurality of groups of sub-data with the plurality of similarities greater than a similarity threshold as a plurality of groups of the sub-data to be analyzed;
clustering the plurality of groups of the sub-data to be analyzed according to a cluster algorithm to generate a plurality of sub-data cluster results;
organizing a plurality of cluster label models of the sub-data cluster results and generating a plurality of organized sub-data cluster results according to the organized cluster label models; and
calculating a cluster stability indicator according to the organized sub-data cluster results.

2. The indicator evaluation method of the cluster stability as claimed in claim 1, wherein before the step for uniformly down-sampling the raw data to be clustered to generate the plurality of groups of the sub-data, further comprising the following steps:
receiving a raw data; and
preprocessing the raw data to generate the raw data to be clustered.

3. The indicator evaluation method of the cluster stability as claimed in claim 2, wherein the raw data comprises at least a numerical feature or a character feature;
wherein the step for preprocessing the raw data further comprises the following sub-steps:
determining whether the raw data comprises the character feature;
when the raw data comprises the character feature, converting the character feature in the raw data to a transformation numerical feature to generate the raw data to be clustered; and
when the raw data excludes the character feature, utilizing the raw data as the raw data to be clustered.

4. The indicator evaluation method of the cluster stability as claimed in claim 2, wherein the raw data comprises at least a numerical feature or a character feature;
wherein the step for preprocessing the raw data further comprises the following sub-steps:
determining whether the raw data comprises the character feature;
when the raw data comprises the character feature, converting the character feature in the raw data to a transformation numerical feature and standardizing the transformation numerical feature to generate the raw data to be clustered; and
when the raw data excludes the character feature, standardizing the numerical feature of the raw data to generate the raw data to be clustered.

5. The indicator evaluation method of the cluster stability as claimed in claim 1, wherein the step for organizing the cluster label models of the sub-data cluster results, and generating the organized sub-data cluster results according to the organized cluster label models comprises the following sub-step:
according to a raw data cluster label model of the raw data cluster results, utilizing a decision tree classifier to overfit a model prediction for the plurality of cluster label models of the plurality of sub-data cluster results to generate the organized sub-data cluster results.

6. The indicator evaluation method of the cluster stability as claimed in claim 1, wherein the step for calculating the cluster stability indicator according to the organized sub-data cluster results comprises the following sub-steps:
calculating a plurality of cluster probabilities of a plurality of cluster labels of a plurality of data points in the raw data to be clustered according to the organized sub-data cluster results; and
averaging a plurality of highest cluster probabilities of each of the plurality of data points in the raw data to be clustered to generate the cluster stability indicator.

7. The indicator evaluation method of the cluster stability as claimed in claim 1, wherein the step for clustering the plurality of groups of the sub-data to be analyzed according to a cluster algorithm to generate a plurality of the sub- data cluster results further comprises the following sub-step:
clustering the raw data to be clustered according to the cluster algorithm to generate a raw data cluster result;
wherein the indicator evaluation method of the cluster stability further comprises the following sub-step:
generating a final cluster result according to the raw data cluster results and the organized sub-data cluster results;
wherein the final cluster result corresponds to the cluster stability indicator.

8. An indicator evaluation system of a cluster stability, comprising:
a processing device, uniformly down-sampling a raw data to be clustered to generate a plurality of groups of sub-data thereof;
wherein the processing device calculates a plurality of similarities of the raw data to be clustered with the plurality of groups of sub-data according to at least one statistical test;
wherein the processing device keeps the plurality of groups of sub-data with the plurality of similarities greater than a similarity threshold as a plurality of groups of the sub-data to be analyzed and clusters the plurality of groups of the sub-data to be analyzed according to a cluster algorithm to generate a plurality of the sub-data cluster results;
wherein the processing device organizes a plurality of cluster label models of the sub-data cluster results, generates a plurality of organized sub-data cluster results according to the organized cluster label models, and calculates a cluster stability indicator according to the organized sub-data cluster results.

9. The indicator evaluation system of the cluster stability as claimed in claim 8, further comprising:
a data storage device, storing a raw data;
wherein the processing device is communicatively connected to the data storage device to access the raw data and preprocesses the raw data to generate the raw data to be clustered.

10. The indicator evaluation system of the cluster stability as claimed in claim 9, wherein the raw data comprises at least a numerical feature or a character feature;
wherein the processing device determines whether the raw data comprises the character feature when the processing device preprocesses the raw data;
wherein when the raw data comprises the character feature, the processing device converts the character feature in the raw data to a transformation numerical feature to generate the raw data to be clustered;
wherein when the raw data excludes the character feature, the processing device utilizes the raw data as the raw data to be clustered.

11. The indicator evaluation system of the cluster stability as claimed in claim 9, wherein the raw data comprises at least a numerical feature or a character feature;
wherein when the processing device preprocesses the raw data, determining whether the raw data comprises the character feature;
wherein when the raw data comprises the character feature, the processing device converts the character feature in the raw data to a transformation numerical feature and standardizes the transformation numerical feature to generate the raw data to be clustered;
wherein when the raw data excludes the character feature, the processing device standardizes the numerical feature of the raw data to generate the raw data to be clustered.

12. The indicator evaluation system of the cluster stability as claimed in claim 8, wherein when the processing device organizes the cluster label models of the sub-data cluster results and generates the organized sub-data cluster results according to the organized cluster label models, the processing device utilizes a decision tree classifier to overfit a model prediction for the cluster label models of the sub-data cluster results according to a raw data cluster label model of the raw data cluster results to generate the organized sub-data cluster results.

13. The indicator evaluation system of the cluster stability as claimed in claim 8, wherein when the processing device calculates the cluster stability indicator according to the organized sub-data cluster results, the processing device calculates a plurality of cluster probabilities of a plurality of cluster labels of a plurality of data points in the raw data to be clustered according to the organized sub-data cluster results and averages a plurality of highest cluster probabilities of each of the plurality of data points in the raw data to be clustered to generate the cluster stability indicator.

14. The indicator evaluation system of the cluster stability as claimed in claim 8, wherein when the processing device clusters the plurality of groups of the sub-data to be analyzed according to the cluster algorithm to generate a plurality of the sub-data cluster results, the processing device clusters the raw data to be clustered to generate a raw data cluster result according to the cluster algorithm;
wherein the processing device generates a final cluster result according to the raw data cluster results and the organized sub-data cluster results;
wherein the final cluster result corresponds to the cluster stability indicator.
